(19) United States
(12) Patent Application Publication
(10) Pub. No.: US 2022/0013001 A1
(43) Pub. Date: Jan. 13, 2022

(54) Personal Protection and Notification System

(71) Applicant: Biju Thomas, Boulder, CO (US)

(72) Inventor: Biju Thomas, Boulder, CO (US)

(21) Appl. No.: 17/305,496

(22) Filed: Jul. 8, 2021

Related U.S. Application Data
(60) Provisional application No. 63/049,851, filed on Jul. 9, 2020.

(51) Int. Cl. G08B 25/01; H04W 4/02; H04W 4/80; H04W 4/90

(52) U.S. Cl. CPC G08B 25/016; H04W 4/025; F41H 9/10; H04W 4/90; H04W 4/80

(57) ABSTRACT

Disclosed herein is a system along with related devices and methods to detect the actuation of a personal defense mechanism, such as a pepper spray. Upon detection, embodiments of the system are configured to detect a location and generate a signal for delivery to parties other than the person that actuated the personal defense mechanism. The system along with its devices and methods may be used to automate the delivery of a notification to at least one pre-designated third party that the user of a personal defense device has actuated the device.

### CROSS REFERENCE TO RELATED APPLICATIONS

This application claims the benefit of priority to U.S. Provisional Patent Application 63/049,851 filed on Jul. 9, 2020, the entire contents of said application hereby incorporated by reference.

### FIELD OF THE INVENTION

The present invention relates to personal safety and communications, particularly in the context of personal defense mechanisms such as pepper spray and automated mobile device communications utilizing geolocation.

### BACKGROUND OF THE INVENTION

Often during walking or athletic activities persons may encounter unknown risks, particularly at night. It has therefore been desirable to carry lights, personal defense mechanisms, cameras, tracking devices and communications systems to mitigate such risks. However, carrying several items often poses a challenge, particularly during athletic activities where means of holding items defies practicality. Moreover, when faced with a risky, panic-inducing or otherwise exigent situation, persons often have trouble when rapidly selecting the most appropriate item for the situation. For instance, one might reach for a cell phone when instead they would prefer to find a pepper spray canister, with potentially devastating consequences.

Another important item to carry during a nighttime excursion for many walkers or athletes is a personal defense mechanism. Often this takes the form of mace, pepper spray, a handgun or a taser. However, a challenge associated such personal defense mechanisms is that they often have devastating consequences when used. When lasting harm is caused by the utilization of such devices, it would be desirable to have a visual record leading up to such utilization. However, personal defense mechanisms known in the prior art lack recording or illumination capabilities. One of the most common devices for a person to carry when walking or engaging in athletic activities at night is a flashlight. However, flashlights and personal defense mechanisms do not incorporate additional signal recordation features, such as features associated with the generation of a communicable electronic signal following the actuation of the device or photograph-taking, or communications of such signals.

While walkers and athletes carry portable cameras, often incorporated into mobile phone devices, but cannot use such a portable camera in an emergency circumstance or while under duress. However, while it would be helpful during an exigent circumstance such as a robbery or other crime event to have a recording of the perpetrator, most cameras require several steps to operate and are generally not immediately available for use at the time of such events without several cumbersome steps. Also, the perpetrator of a crime may attempt to remove the camera or the photographs taken of a crime. Further, while it would be helpful to have a recording of the events leading up to harmful actions during the usage of a personal defense mechanism, most cameras are not incorporated into or automatically toggled in conjunction with the usage of a personal defense mechanism.

Moreover, tracking devices and communications systems are generally desirable to carry when facing risky circumstances, particularly at night. However, the actuation of tracking devices or communications systems during exigent circumstances, and/or in conjunction with the usage personal defense mechanisms, often does not take place without several additionally needed steps. In particular, while a person may have a tracking device and/or a communication system in an exigent circumstance, that person may not have the ability to engage such items if that person becomes incapacitated.

Often it remains desirable to identify the perpetrator of a crime following its commission. While the actuation of a camera may capture the act if a camera records the crime in progress, often lighting and blur prevent a clear picture. It remains desirable to have a mechanism to mark a perpetrator during the act of a crime for purposes associated with subsequent identification.

Therefore, it remains desirable to have an improved personal defense system incorporating automated recording and communication and tracking features.

### SUMMARY OF THE INVENTION

The preferred embodiment of the invention comprises an integrated protection system incorporating an actuation signal generator actuator and a communicative linkage module configured to transmit an electronic signal comprising GPS coordinates to at least one predefined destination following the actuation of the personal device system.

### BRIEF DESCRIPTION OF THE FIGURES

FIG. 1 is a side view of an embodiment of the integrated protection system in the form of a flashlight.

FIG. 2 is a cross-sectional side view of the integrated protection system and its components in an embodiment.

FIG. 3 is a front view of an embodiment of the flashlight face in an embodiment,

FIG. 4a depicts the actuator position in a non-deployed configuration in an embodiment.

FIG. 4b depicts the actuator in a semi-deployed position in an embodiment.

FIG. 4c depicts the actuator in a fully deployed position in an embodiment.

FIG. 5 is a top side view of an embodiment of the integrated protection system substantially in the form of a handgun.

FIG. 6 depicts a graphical user interface showing recently uploaded images in an embodiment.

FIG. 7 depicts a graphical user interface displaying contacts in an embodiment.

FIG. 8 depicts a graphical user interface displaying messages in an embodiment.

FIG. 9 depicts a graphical user interface displaying toggles to turn on or off different components of the integrated protection system in an embodiment.

FIG. 10 depicts an embodiment of the integrated protection system mounted on a bar, optionally a handlebar.

FIG. 11 depicts an embodiment of the integrated protection system and a wristband mount while worn by a wearer.

FIG. 12 depicts a cross-sectional view of the system and the components therein in an embodiment.

### DETAILED DESCRIPTION

The preferred embodiment of the invention comprises an integrated personal defense system incorporating a personal defense device, one or more battery(ies) 450 and a communicative linkage module configured to transmit a signal that the actuation of the personal defense device has occurred along coordinates captured at the time of the actuation. In embodiments of the invention, the personal defense device comprises a pepper spray canister, wherein in addition to the generation of a signal detectible by the communicative linkage module indicating actuation, the actuation of the pepper spray nozzle 112 takes place in such a manner to emit pepper spray from the pepper spray canister 111. In embodiments of the invention, the system further comprises a camera 120, with the communicative linkage module configured to transmit a photograph and/or recording generated by the camera 120. In embodiments of the invention, the system further comprises a light. In various embodiments, the integrated personal defense system comprises an enclosure. In the preferred embodiment, the enclosure comprises a shell in a shape substantially similar to a flashlight, optionally comprising stainless steel.

Various embodiments of the invention comprise a personal defense mechanism. In one embodiment, the personal defense mechanism comprises a pepper spray canister 111 and a pepper spray nozzle 112, wherein the pepper spray nozzle 112 is configured to emit pepper spray from the pepper spray canister 111 upon the placement of the actuator 300 into its fully deployed position 310. In another embodiment of the invention, the personal defense mechanism comprises a light, optionally a flashlight, the actuator incorporated within the on/off button of the flashlight. In another embodiment of the invention, the personal defense mechanism comprises a gun 210, optionally a handgun, and optionally in combination with a pepper spray canister 111. When activated by placement of the actuator 300 in its fully deployed position 310, the gun 210 is fired in the case where the personal defense mechanism comprises a gun 210. When activated by placement of the actuator 300 in its fully deployed position 310, the pepper spray is deployed in the example where the personal defense mechanism consists only of a pepper spray canister 111 configured to emit pepper spray through a pepper spray nozzle 112. In various embodiments, the placement of the actuator 300 from one position (i.e. its partially deployed position 305) to another position (i.e. its fully deployed position 310) is accomplished by depressing or pulling back the actuator 300.

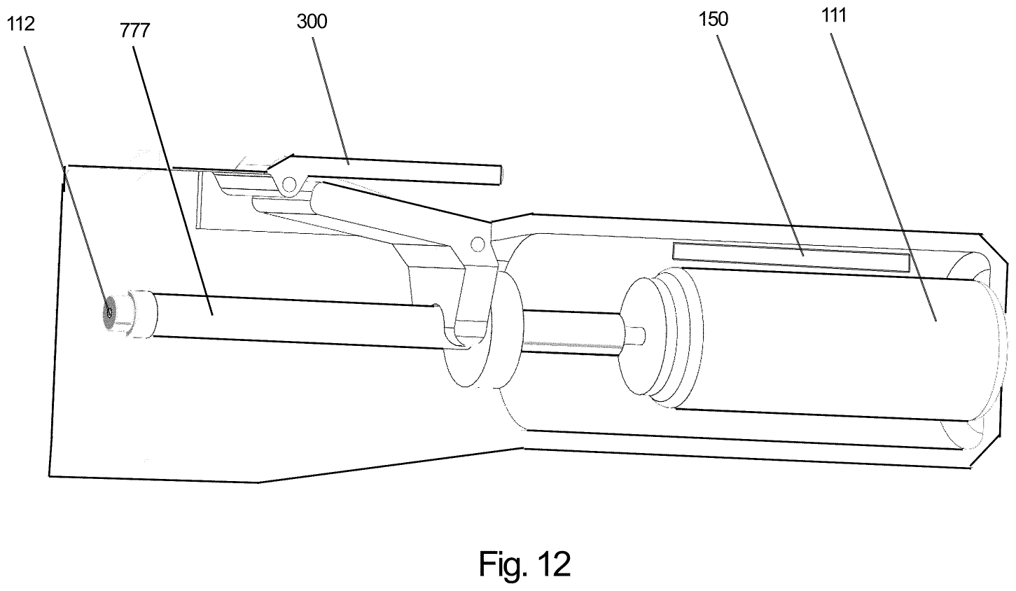

In various embodiments of the system, the entirety of the system is enclosed within a single body as depicted in FIG. 12. In such embodiments, the system may feature an elongated tube 777 creating a passage for the contents of the pepper spray canister to travel through to the front face of the single body, separated from the remainder of the components of the system.

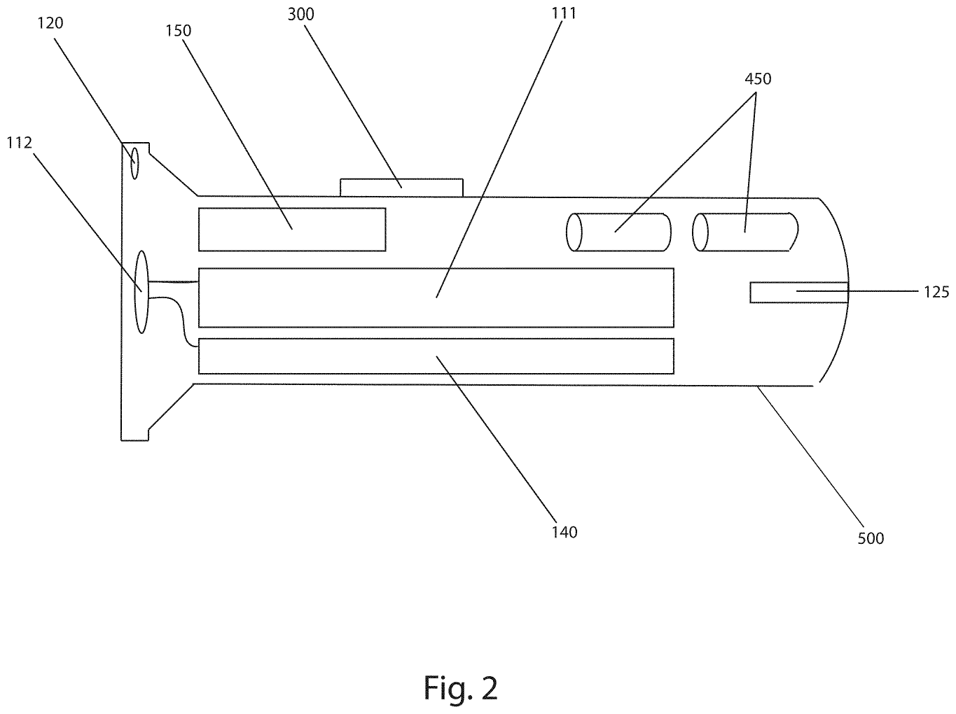

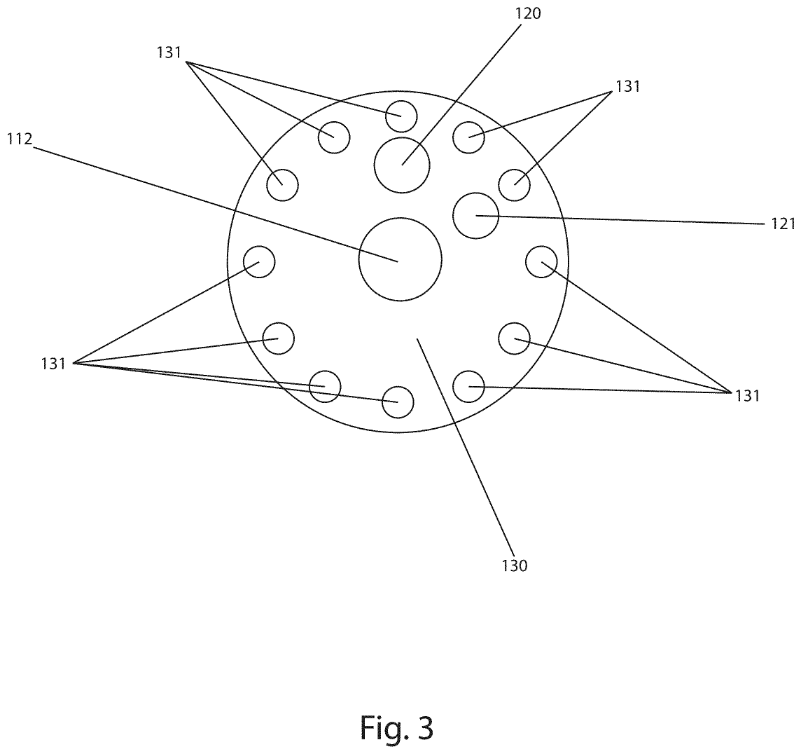

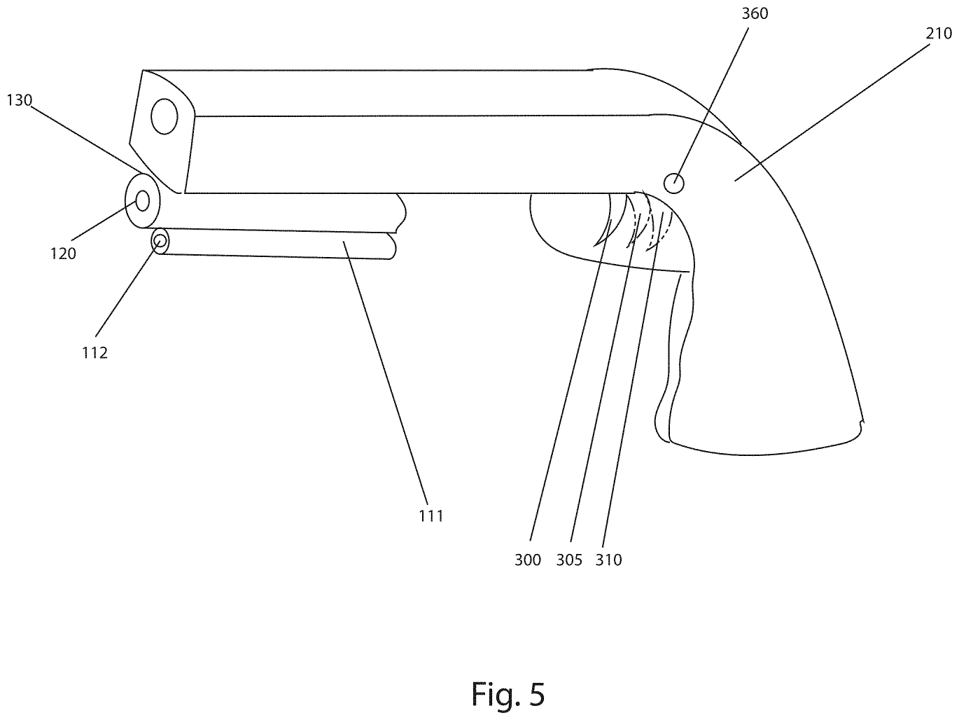

An embodiment of the invention additionally comprises a light and a camera placed on the front face of the enclosure. In various embodiments, the enclosure comprises a form substantially similar to a flashlight, as depicted in FIG. 12. In an embodiment of the invention, the entirety of the system is enclosed within a body of similar dimensions to a standard flashlight 500, as depicted in FIG. 2. In an alternative embodiment of the invention the entirety of the system is incorporated into a 210, gun comprising an attached or integrated flashlight as depicted in FIG. 5. In various embodiments of the invention, a light is integrated into or attached to the integrated personal defense system. In the preferred embodiment of the invention, the light consists of one or more LED light(s) 131, optionally oriented along the flashlight face 130 as depicted in FIG. 3. In an alternative embodiment of the system, the body is configured in such dimensions applicable for attachment onto the handlebar of a bike. In various embodiments of the invention, the integrated personal defense system may be configured for use in any casing associated with any personal defense mechanism device.

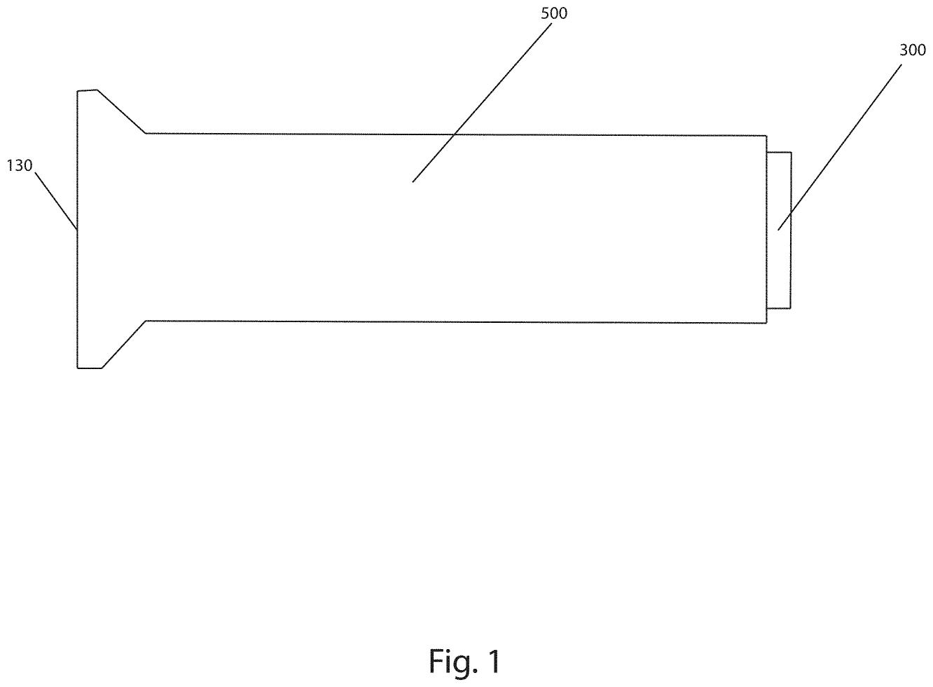

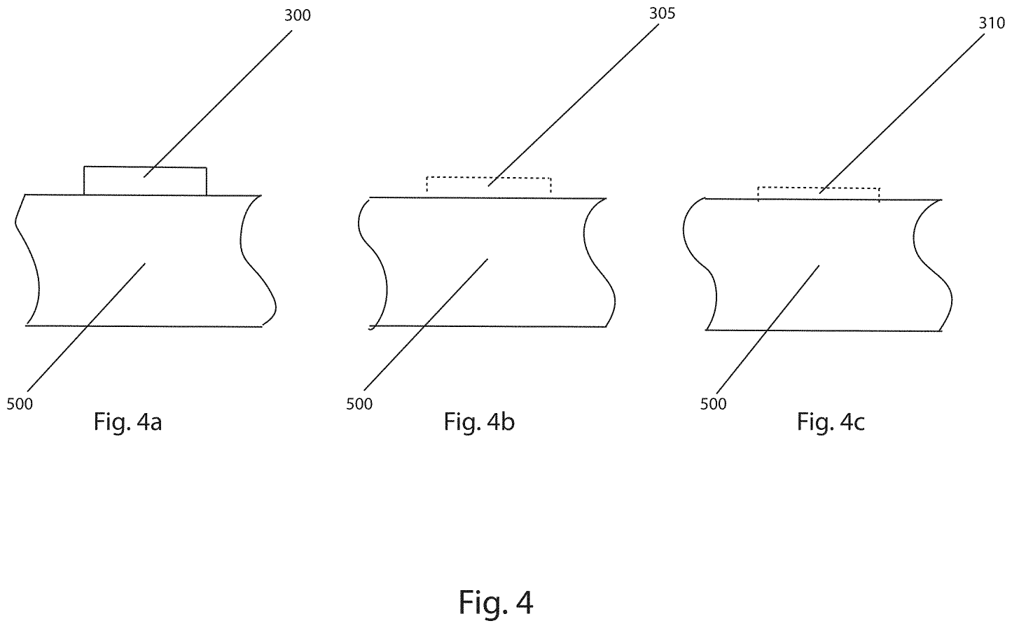

In an embodiment of the invention, the actuator 300 consists of a button as depicted, for example, by FIG. 1. In an alternative embodiment of the invention, the actuator 300 consists of a trigger, as depicted on FIG. 5. In the preferred embodiment, the trigger is located to the rear of the front face of the enclosure of the system, as depicted in FIG. 12, and in such embodiment is intended for utilization via actuation by the user's thumb as if holding a flashlight. In various embodiments, the actuator is configured to activate the camera when deployed only to the partially deployed position 305 and to activate the personal defense mechanism when placed into its fully deployed position 310. A non-deployed configuration of the actuator in the example where the actuator 300 is configured as a button is depicted by FIG. 4a. The partially deployed position 305, in the example where the actuator 300 is configured as a button, occurs when the button is depressed halfway or thereabout, as depicted by FIG. 4b. The full position, in the example where the actuator 300 is configured as a button, occurs when the button is placed into its fully deployed position 310, as depicted by FIG. 4c. The partially deployed position 305 in the case of a trigger occurs when the trigger is pulled back halfway or thereabout as depicted in FIG. 5. The partially deployed position 310 in the case of a trigger occurs when the trigger is pulled back fully as depicted in FIG. 5. In an embodiment of the invention featuring a safety 360, which either permits or blocks an actuator 300 from usage, the actuation of the safety 360 automatically causes the camera 120 to begin recording and transmitting the images produced via the communicative linkage module 150, optionally as described elsewhere herein.

In an embodiment, when the actuator is deployed into the partially deployed position 305, the light is additionally activated to illuminate whatever the integrated protection system is pointed at. In an embodiment, when the actuator 300 is deployed into the partially deployed position 305, the camera 120 is additionally activated to capture one or more photograph(s) and/or capture a video recording of whatever the integrated protection system is pointed at. In an example, the integrated protection system also comprises a microphone 121 to capture a sound recording at any time upon the activation of the camera 120, and deliver the sound recording to the smartphone 152 and optionally to cloud storage via the communicative linkage module 150.

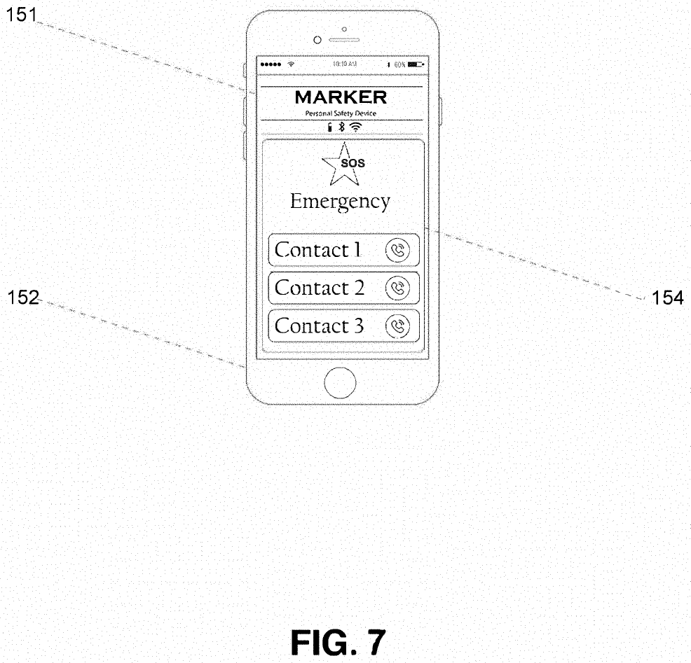

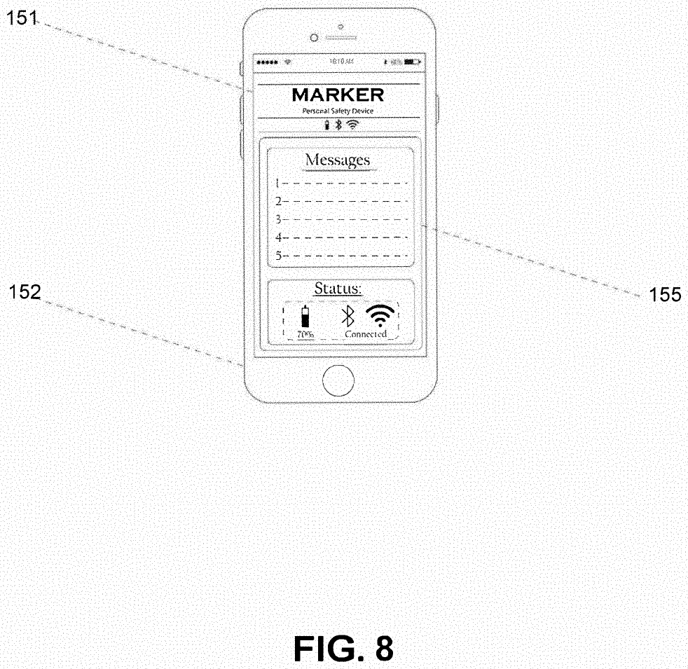

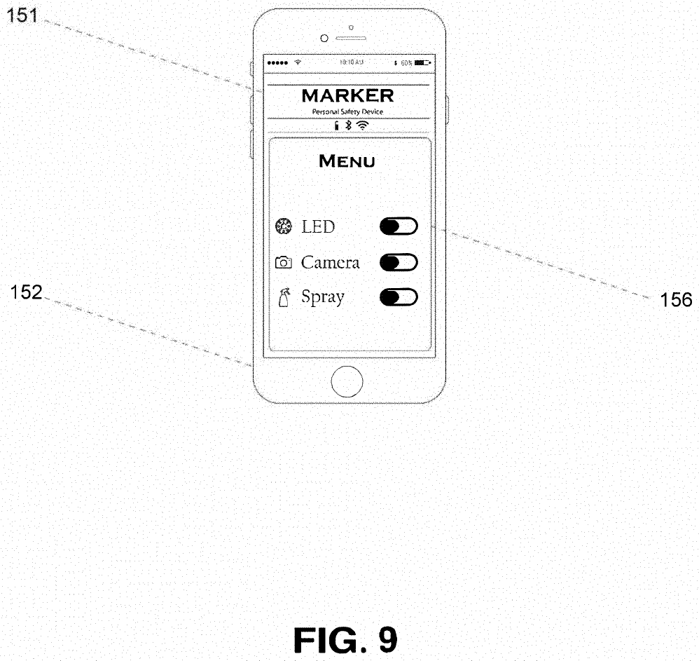

The preferred embodiment of the invention further comprises a communicative linkage module 150. The communicative linkage module 150 comprises a wireless connection mechanism, which in the preferred embodiment consists of a Bluetooth system configured in association with methods well known by those skilled in the art. In various embodiments, within the system, a button or sensor is placed within the enclosure of the system to activate the communicative linkage module 150 upon actuation of the trigger, thereby delivering an instruction to the smartphone to send a communication to a predefined communication destination (i.e. a SMS recipient, a phone number, an email recipient or a notification delivered via an operating system) that the system has been activated, with the GPS coordinates and other preprogrammed identifying information. The communicative linkage module 150 in one configuration comprises a connection to a smartphone 152 mobile device comprising a GPS receiver, which may be configured to send photographs collected by the camera of the integrated protection system (and/or optionally the camera of the smartphone 152 mobile device itself) and location information, optionally comprising or in association with messages 155, to third parties. In an embodiment, the third parties may be organized into a pre-defined contact list 154, optionally as depicted in FIG. 7, that receives photographs and location information automatically upon the deployment of the actuator 300 into its fully deployed position 310, optionally via an application configured to operate on the smartphone 152 mobile device linked to the integrated protection system via the communicative linkage module 150 and optionally depict information relevant to the specific communicatively linked integrated protection mechanism and its operation 151. In an embodiment, the graphical user interface of a smartphone 152 may incorporate a toggle section 156 configured to turn individual components and or features of the integrated protection system on or off via the smartphone 152, as depicted in FIG. 9.

In an embodiment of the invention, the system is configured to deploy a marker upon the placement of the actuator 300 into its fully deployed position 310. The marker in an example comprises a chemical dye configured to deploy a color and/or pattern onto a target that the integrated protection system is aimed at. The color and/or pattern are useful in subsequent identification of the target following activation of the integrated personal defense system. In an embodiment, the integrated protection system further comprises a marker canister 140. In an example, the marker canister 140 further features a tubular connection to the pepper spray nozzle 112 to facilitate the emission of marker material and/or fluid.

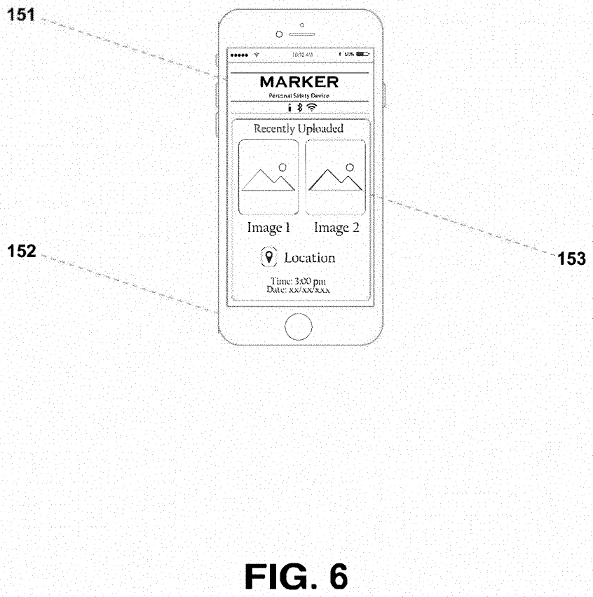

An embodiment of the invention further comprises a camera 120. In the preferred embodiment, the camera 120 is placed such that the lens faces outward from the front face of the enclosure. The camera 120 in an embodiment consists of a configuration similar to cameras utilized in mobile phone devices. In the preferred embodiment, the camera 120 incorporates a multi-shot night mode to allow for the capture of images in low-light scenarios. In an embodiment, the camera 120 may utilize CMOS active-pixel image sensors. The camera interacts with the communicative linkage module 150, and optionally a processor, to generate a stream of images in real time or near real time for transfer to devices connected to the integrated protection system via the communicative linkage module 150 via mechanisms that are well known in the art. In an example, the integrated protection system also features a camera storage card receptacle 125 to facilitate the placement of a storage card within the system for on-device recording as is well understood in the art. When activated, the camera 120 may capture and transmit via the communicative linkage module 150 a short burst video recording of whatever the integrated protection system, and thereby the camera 120, is aiming at. In an embodiment, when activated, the camera 120 will automatically record a video of a predetermined amount of time. In one example, the camera will record a video for a period of 30 seconds. Following the recording of the video and/or the capture of a static image, the video and/or static image is transferred via the communicative linkage module 150 to a smartphone. In one example, the system is configured such that the video and/or static image are immediately transferred to a cloud storage via communication mechanisms associated with a smartphone 152 upon receipt of the video and/or static image via the communicative linkage module 150. FIG. 6 depicts an example of a graphical user interface associated with the smartphone 152 depicting the transferred image 153. Such graphical user interface may optionally represent the image stored in memory of the smartphone 152 or recaptured from the cloud storage via communication mechanisms associated with the smartphone.

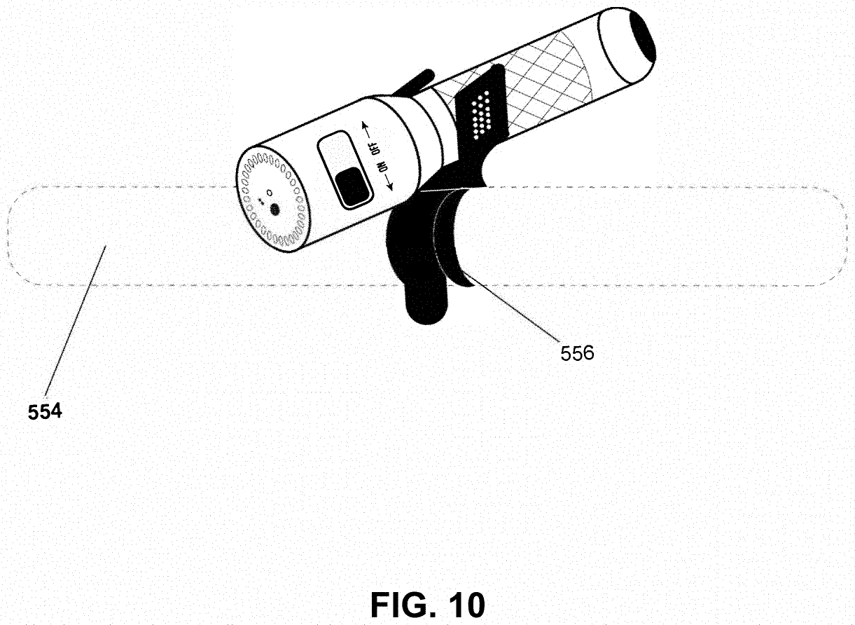

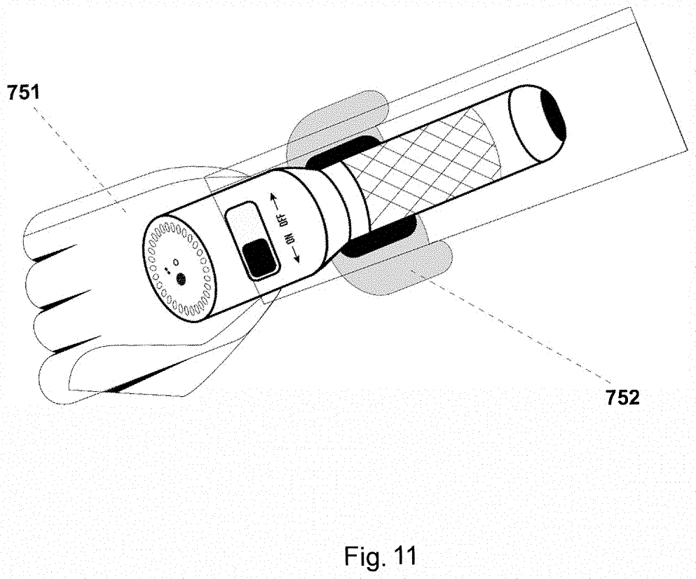

In various embodiments of the invention, a mount 556 is utilized to affix the integrated protection system to another mass. In one example, a mount 556 is utilized to affix the integrated protection system to an elongate bar 554, such as the handlebar of a bike, as depicted in FIG. 10. In another example, the mount 556 takes the form of a wearable 752, such as the wristband depicted in FIG. 11, such that the integrated protection system can be worn by a human or animal, optionally on an appendage 751.

The following presents the preferred method of use for the generation of an electronic signal following the actuation of the personal defense mechanism described herein and the communication of the electronic signal in association with embodiments of the invention.

First, a user of the personal defense mechanism performs the step of actuating personal defense mechanism. This step is performed in various embodiments when the user activates the trigger or other actuator associated with an embodiment of the invention.

Following actuation, the system performs the step generating the electronic signal by detecting that the personal defense mechanism has been actuated, optionally by physical contact of a sensor or button attached to the communicative linkage module within the enclosure and a surface of a body connected to the actuator or trigger. The electronic signal may comprise a pre-set message configured via a smartphone application comprising a list of destination addresses (i.e. phone numbers to deliver a SMS message or pre-recorded voice message, or an email address for e-mail delivery, for example), the GPS coordinates received by immediate request from the bluetooth-connected smartphone, and message contents (i.e. “this message is to notify you that Jane Doe has activated her pepper spray canister at GPS coordinates XXX, located near 123 Main Street, Anytown, Mich., 48708”, for example).

In various embodiments, the system performs the step of communicating the electronic signal, which in the preferred embodiment takes place via a communicative linkage module. In various embodiments, the communicative linkage module comprises a Bluetooth low energy emitter antenna and related apparatuses. In various embodiments, the communicative linkage module is configured to connect with a smartphone via Bluetooth and/or via other communication mechanisms as well understood by those skilled in the art. In various embodiments, the communicative linkage module is configured to receive the GPS location coordinates from a communicatively linked smartphone device, and include the GPS coordinates with the electronic signal delivered via the communicative linkage module.

In various embodiments, following the step of actuating a personal defense mechanism, the system performs the steps of activating a photographic or video camera embedded within the personal defense mechanism or the container fully or partially enclosing the personal defense mechanism, and recording and storing a photograph or video collected by the photographic or video camera. In embodiments of the invention, the activation of the camera produces a photo or video which may be stored on a storage medium located within the system itself or within a communicatively linked smartphone device (or storage medium communicatively linked thereto) in association with mechanisms as well understood by those skilled in the art. In various embodiments, the activating a photographic or video camera step is performed by the system automatically without any required intervention by the user.

In various embodiments of the invention, the system performs the steps of communicating the electronic signal, optionally in association with transmitting the photograph or video and/or the GPS coordinates in association with the electronic actuation signal and configuring the recipients of a transmitted electronic signal, photograph or video following the actuation of the personal defense mechanism with an application operating on a mobile device communicatively connected to the personal defense mechanism via a linked communicative linkage module. In various embodiments, the communicating the electronic signal step takes place in association with the communicative linkage module. In various embodiments, the communicating the electronic signal step involves delivering the electronic signal to a communicatively linked smartphone first, and thereafter (in association with the antenna and communicative mechanisms of the smartphone, for example 5G, 4G, Edge, or other wireless communications mechanisms, optionally formatted as SMS, voice message, or e-mail messages, as well understood by those skilled in the art) communicating the electronic signal to at least one third party destination or optionally a plurality of destinations. In various embodiments, the at least one third party destination or plurality of destinations is pre-configured, optionally in association with an app operating on a user's smartphone, prior to the actuation of the system to pre-designate the message associated with the electronic signal, optionally including a textual message defined by the user, appended with a video or photograph taken by the camera and/or the GPS coordinates associated with the location that the actuator was activated by the user, and the destinations (i.e. smartphone devices or computers of people other than the primary user, for example) to deliver the electronic signal.

In the foregoing specification, specific embodiments have been described. However, one of ordinary skill in the art appreciates that various modifications and changes can be made without departing from the scope of the disclosure as set forth in the claims to follow in a subsequent disclosure. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all subsequent claims.

Any noun in the singular is also intended to encompass the noun in the plural and vice versa, unless specifically stated as otherwise intended. Any pronoun or other identifier in the female form is also intended to encompass the pronoun or other identifier in the male form and vice versa, unless specifically stated as otherwise intended. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled,” “connected” and “linked” as used herein is defined as connected, although not necessarily directly and not necessarily mechanically. A device or structure that is “configured” in a certain way is configured in at least that way, but may also be configured in ways that are not listed.

It is to be understood that the invention is not limited to the precise configuration and components illustrated above. Various modifications, changes and variations may be made in the arrangement, operation and details of the methods and apparatus described above without departing from the scope of the disclosure. While the foregoing is directed to aspects of the present disclosure, other and further aspects of the disclosure may be devised without departing from the basic scope thereof.

I claim:

1. A system for the detection of the actuation of a personal device mechanism and the transmission of an electronic signal following the actuation of the personal device mechanism, comprising:
an enclosure;
a mobile device comprising a GPS geolocator;
a personal defense device;
a communicative linkage module; and
a battery.

2. The system of claim 1, the personal defense device comprising a pepper spray canister.

3. The system of claim 1, further comprising a container to hold the personal defense device, actuation detector, the communicative linkage module and the battery.

4. The system of claim 1, the communicative linkage module comprising a Bluetooth system.

5. The system of claim 4, the communicative linkage module configured to communicatively connect with the mobile device.

6. The system of claim 1, the enclosure comprising stainless steel.

7. A method for the generation of an electronic signal following the actuation of a personal defense mechanism and the communication of the electronic signal, comprising:
actuating the personal defense mechanism,
generating the electronic signal comprising a textual message and GPS coordinates retrieved from a communicatively linked smartphone, and
communicating the electronic signal via a communicative linkage module.

8. The method of claim 7, further comprising:
following the step of actuating a personal defense mechanism, activating a photographic or video camera embedded within the personal defense mechanism or the container fully or partially enclosing the personal defense mechanism;
recording and storing a photograph or video collected by the photographic or video camera; and
following the step of communicating the electronic signal, transmitting the photograph or video in association with the electronic actuation signal.

9. The method of claim 7, further comprising:
configuring the recipients of a transmitted electronic signal, photograph or video following the actuation of the personal defense mechanism with an application operating on a mobile device communicatively connected to the personal defense mechanism via a linked communicative linkage module.
